(19) United States
(12) Patent Application Publication
(10) Pub. No.: US 2022/0277198 A1
(43) Pub. Date: Sep. 1, 2022

(54) METHOD FOR DISCRIMINATING CLASS OF DATA TO BE DISCRIMINATED USING MACHINE LEARNING MODEL, INFORMATION PROCESSING DEVICE, AND COMPUTER PROGRAM

(71) Applicant: SEIKO EPSON CORPORATION, Tokyo (JP)

(72) Inventors: Ryoki WATANABE, Matsumoto-shi (JP); Hikaru KURASAWA, Matsumoto-shi (JP); Shin NISHIMURA, Shiojiri-shi (JP); Kana KANAZAWA, Shiojiri-shi (JP)

(73) Assignee: SEIKO EPSON CORPORATION, Tokyo (JP)

(21) Appl. No.: 17/680,928

(22) Filed: Feb. 25, 2022

(30) Foreign Application Priority Data
Feb. 26, 2021 (JP) 2021-029826

(51) Int. Cl. G06N 3/08; G06N 3/04

(52) U.S. Cl. CPC G06N 3/08; G06N 3/04

(57) ABSTRACT

A class discrimination method includes: (a) a step of preparing, for each class, a known feature spectrum group obtained based on an output of a specific layer among a plurality of vector neuron layers when a plurality of pieces of training data are input to a machine learning model; and (b) a step of executing a class discrimination processing of the data to be discriminated using the machine learning model and the known feature spectrum group. The step (b) includes: (b1) a step of calculating a feature spectrum based on an output of the specific layer according to the data to be discriminated to the machine model; (b2) a step for each of the one or more classes; (b3) a step of creating an explanatory text of a class discrimination result for the data to be discriminated according to the similarity; and (b4) a step of outputting the explanatory text.

The present application is based on, and claims priority from JP Application Serial Number 2021-029826, filed Feb. 26, 2021, the disclosure of which is hereby incorporated by reference herein in its entirety.

### BACKGROUND

### 1. Technical Field

The present disclosure relates to a method for discriminating a class of data to be discriminated using a machine learning model, an information processing device, and a computer program.

### 2. Related Art

U.S. Pat. No. 5,210,798 and WO2019/083553 disclose a vector neural network type machine learning model using a vector neuron, which is called a capsule network. The vector neuron means a neuron whose input and output are vectors. The capsule network is a machine learning model in which a vector neuron called a capsule is set as a node of the network. The vector neural network type machine learning model such as the capsule network can be used for class discrimination of input data.

However, in the related art, when a class discrimination is performed using a machine learning model, a result of the class discrimination is output, but a discrimination basis for the output class is unknown, and it is difficult to know the discrimination basis.

### SUMMARY

A first aspect of the present disclosure provides a method for discriminating a class of data to be discriminated using a vector neural network type machine learning model including a plurality of vector neuron layers. The method includes: (a) a step of preparing, for each class of one or more classes, a known feature spectrum group obtained based on an output of a specific layer among the plurality of vector neuron layers when a plurality of pieces of training data are input to the machine learning model; and (b) a step of executing a class discrimination processing of the data to be discriminated using the machine learning model and the known feature spectrum group. The step (b) includes: (b1) a step of calculating a feature spectrum based on an output of the specific layer according to an input of the data to be discriminated to the machine learning model; (b2) a step of calculating a similarity between the feature spectrum and the known feature spectrum group for each class of the one or more classes; (b3) a step of creating an explanatory text of a class discrimination result for the data to be discriminated according to the similarity; and (b4) a step of outputting the explanatory text.

A second aspect of the present disclosure provides an information processing device that executes a class discrimination processing of discriminating a class of data to be discriminated using a vector neural network type machine learning model including a plurality of vector neuron layers. The information processing device includes a memory configured to store the machine learning model; and a processor configured to perform calculation using the machine learning model. The processor is configured to execute: (a) a processing of reading, from the memory, a known feature spectrum group for each class of one or more classes, the known feature spectrum group being obtained based on an output of a specific layer among the plurality of vector neuron layers when a plurality of pieces of training data are input to the machine learning model; and (b) a processing of executing the class discrimination processing of the data to be discriminated using the machine learning model and the known feature spectrum group. The processing (b) includes: (b1) a processing of calculating a feature spectrum based on an output of the specific layer according to an input of the data to be discriminated to the machine learning model; (b2) a processing of calculating a similarity between the feature spectrum and the known feature spectrum group for each class of the one or more classes; (b3) a processing of creating an explanatory text of a class discrimination result for the data to be discriminated according to the similarity; and (b4) a processing of outputting the explanatory text.

A third aspect of the present disclosure provides a non-transitory computer-readable storage medium storing a computer program causing a processor to execute a class discrimination processing of discriminating a class of data to be discriminated using a vector neural network type machine learning model including a plurality of vector neuron layers. The computer program causes the processor to execute (a) a processing of reading, from a memory, a known feature spectrum group for each class of one or more classes, the known feature spectrum group being obtained based on an output of a specific layer among the plurality of vector neuron layers when a plurality of pieces of training data are input to the machine learning model; and (b) a processing of executing the class discrimination processing of the data to be discriminated using the machine learning model and the known feature spectrum group. The processing (b) includes: (b1) a processing of calculating a feature spectrum based on an output of the specific layer according to an input of the data to be discriminated to the machine learning model; (b2) a processing of calculating a similarity between the feature spectrum and the known feature spectrum group for each class of the one or more classes; (b3) a processing of creating an explanatory text of a class discrimination result for the data to be discriminated according to the similarity; and (b4) a processing of outputting the explanatory text.

### BRIEF DESCRIPTION OF THE DRAWINGS

FIG. 1 is a block diagram of a class discrimination system according to a first embodiment.

FIG. 2 is a block diagram of an information processing device.

FIG. 3 is a diagram illustrating a configuration of a machine learning model.

FIG. 4 is a diagram illustrating another configuration of the machine learning model.

FIG. 5 is a flowchart showing a preparation step of the machine learning model.

FIG. 6 is a diagram illustrating a feature spectrum.

FIG. 7 is a diagram illustrating a state in which a known feature spectrum group is created using training data.

FIG. 8 is a diagram illustrating a configuration of the known feature spectrum group.

FIG. 9 is a flowchart showing a processing procedure of a medium discrimination and printing step.

FIG. 10 is a diagram illustrating a state in which a similarity for data to be discriminated is obtained.

FIG. 11 is a diagram illustrating a processing of creating an explanatory text according to the first embodiment.

FIG. 12 is a diagram illustrating an example of an explanatory text displayed on a display unit.

FIG. 13 is a diagram illustrating a processing of creating an explanatory text according to a second embodiment.

FIG. 14 is a graph showing an infrared absorption spectrum of a discrimination object according to a third embodiment.

FIG. 15 is a diagram illustrating a processing of creating an explanatory text according to the third embodiment.

FIG. 16 is a diagram illustrating a first calculation method of a similarity.

FIG. 17 is a diagram illustrating a second calculation method of the similarity.

FIG. 18 is a diagram illustrating a method of determining a discrimination class using a plurality of specific layers.

### DESCRIPTION OF EXEMPLARY EMBODIMENTS

### A. First Embodiment

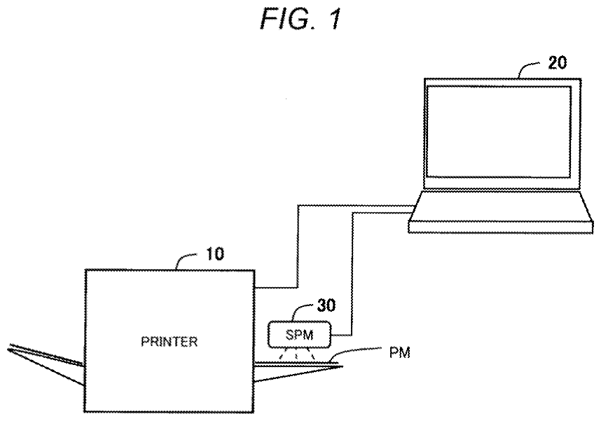

FIG. 1 is a block diagram showing a class discrimination system according to a first embodiment. This class discrimination system is a printing system including a printer 10, an information processing device 20, and a spectrometer 30. The spectrometer 30 can acquire a spectral reflectance by performing spectroscopic measurement on a print medium PM which is in an unprinted state and is used in the printer 10. In the present disclosure, the spectral reflectance is also referred to as “spectral data”. The spectrometer 30 includes, for example, a wavelength tunable interference spectral filter and a monochrome image sensor. The spectral data obtained by the spectrometer 30 is used as data to be discriminated that can be input to a machine learning model described later. The information processing device 20 executes class discrimination processing of the spectral data using the machine learning model and determines whether the print medium PM corresponds to any of a plurality of classes. A “class of the print medium PM” means a type of the print medium PM. The information processing device 20 controls the printer 10 to execute printing under an appropriate printing condition corresponding to the type of the print medium PM. Further, the class discrimination system according to the present disclosure may be implemented as a system other than the printing system, and may be implemented as a system that performs class discrimination using, for example, a discrimination target image, one-dimensional data other than the spectral data, a spectral image, time-series data, or the like as the data to be discriminated.

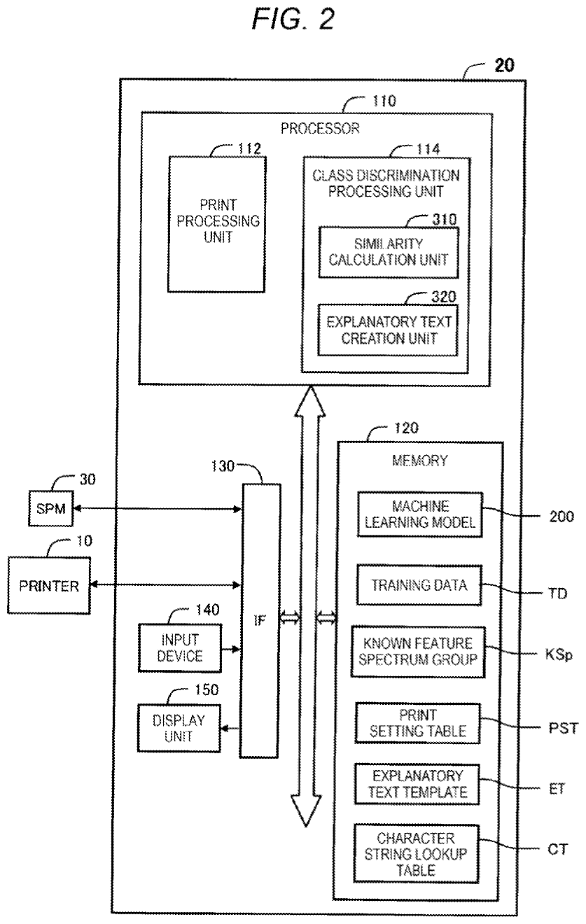

FIG. 2 is a block diagram showing functions of the information processing device 20. The information processing device 20 includes a processor 110, a memory 120, an interface circuit 130, and an input device 140 and a display unit 150 that are coupled to the interface circuit 130. The spectrometer 30 and the printer 10 are also coupled to the interface circuit 130. The processor 110 has, for example but not limited to, a function of executing a processing described in detail below, and a function of displaying data obtained by the processing and data generated in a process of the processing on the display unit 150.

The processor 110 functions as a print processing unit 112 that executes print processing using the printer 10, and functions as a class discrimination processing unit 114 that executes the class discrimination processing of the spectral data of the print medium PM. The class discrimination processing unit 114 includes a similarity calculation unit 310 and an explanatory text creation unit 320. The print processing unit 112 and the class discrimination processing unit 114 are implemented by the processor 110 executing a computer program stored in the memory 120. However, these units 112 and 114 may be implemented by a hardware circuit. The processor in the present specification is a term including such a hardware circuit. In addition, the processor that executes the class discrimination processing may be a processor provided in a remote computer coupled to the information processing device 20 via a network.

The memory 120 stores a machine learning model 200, training data TD, a known feature spectrum group KSp, a print setting table PST, an explanatory text template ET, and a character string lookup table CT. The memory 120 may further store a character string generation database used for generating a character string, a corresponding dictionary, and the like. The machine learning model 200 is used in a processing performed by the class discrimination processing unit 114. A configuration example and operation of the machine learning model 200 will be described later. The training data TD is a set of labeled data used for learning of the machine learning model 200. In the present embodiment, the training data TD is a set of the spectral data. The known feature spectrum group KSp is a set of feature spectra obtained when the training data TD is input to the learned machine learning model 200. The feature spectrum will be described later. The print setting table PST is a table in which a print setting suitable for each print medium is registered. The explanatory text template ET and the character string lookup table CT are used for the explanatory text creation processing performed by the explanatory text creation unit 320. The character string lookup table CT can also be called a “character string selection unit CT”.

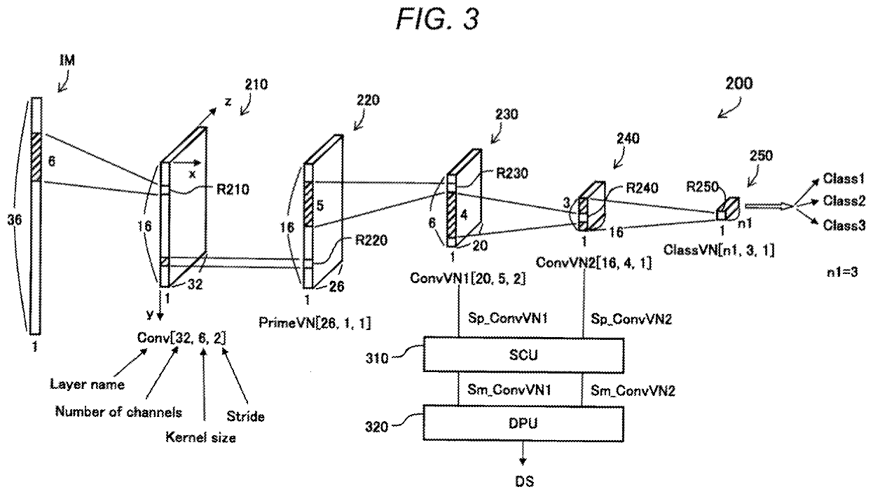

FIG. 3 is a diagram illustrating a configuration of the machine learning model 200. The machine learning model 200 includes, in order from an input data IM side, a convolutional layer 210, a primary vector neuron layer 220, a first convolutional vector neuron layer 230, a second convolutional vector neuron layer 240, and a classification vector neuron layer 250. Among these five layers 210 to 250, the convolutional layer 210 is a lowest layer, and the classification vector neuron layer 250 is an uppermost layer. In the following description, the layers 210 to 250 are also referred to as a “Cony layer 210”, a “PrimeVN layer 220”, a “ConvVN1 layer 230”, a “ConvVN2 layer 240”, and a “ClassVN layer 250”, respectively.

In the present embodiment, since the input data IM is the spectral data, the input data IM is data of a one-dimensional array. For example, the input data IM is data obtained by extracting 36 representative values every 10 nm from the spectral data in a range of 380 nm to 730 nm.

In an example of FIG. 3, two convolutional vector neuron layers 230 and 240 are used, but the number of convolutional vector neuron layers may be any member, and the convolutional vector neuron layer may be omitted. However, it is preferable to use one or more convolutional vector neuron layers.

Configurations of the layers 210 to 250 in FIG. 3 can be described as follows.

### Description of Configuration of Machine Learning Model 200

Conv layer 210: Conv [32, 6, 2]
PrimeVN layer 220: PrimeVN [26, 1, 1]
ConvVN1 layer 230: ConvVN1 [20, 5, 2]
ConvVN2 layer 240: ConvVN2 [16, 4, 1]
ClassVN layer 250: ClassVN [n1, 3, 1]
Vector dimension VD: VD=16

In the description of these layers 210 to 250, a character string before parentheses is a layer name, and numbers in the parentheses are the number of channels, a surface size of a kernel, and a stride in this order. For example, a layer name of the Conv layer 210 is “Conv”, the number of channels is 32, a surface size of the kernel is 1×6, and a stride is 2. In FIG. 3, these descriptions are shown below each layer. A hatched rectangle drawn in each layer represents a surface size of the kernel used when an output vector of an adjacent upper layer is calculated. In the present embodiment, since the input data IM is the data of a one-dimensional array, the surface size of the kernel is also one dimensional. Values of parameters used in the descriptions of the layers 210 to 250 are merely examples and can be freely changed.

The Conv layer 210 is a layer composed of scalar neurons. The other four layers 220 to 250 are layers each composed of vector neurons. The vector neuron is a neuron that inputs and outputs a vector. In the above description, a dimension of the output vector of each vector neuron is 16, which is constant. In the following description, a phrase “node” is used as an upper concept of the scalar neuron and the vector neuron.

In FIG. 3, a first axis x and a second axis y that define plane coordinates of a node array and a third axis z that represents a depth are shown for the Conv layer 210. In addition, it is shown that sizes of the Conv layer 210 in x, y, and z directions are 1, 16, and 32. The size in the x direction and the size in the y direction are called “resolution”. In the present embodiment, the resolution in the x direction is always 1. The size in the z direction is the number of channels. These three axes x, y, and z are used as coordinate axes indicating positions of the nodes in other layers. However, in FIG. 3, the axes x, y, and z are not illustrated in layers other than the Conv layer 210.

As well known, a resolution W1 in the y direction after convolution is given by the following equation.

W1=Ceil{(W0−Wk+1)/S} (1)

Here, W0 is a resolution before convolution, Wk is the surface size of the kernel, S is the stride, and Ceil{X} is a function for performing a calculation of rounding up X. Further, as the Ceil{X}, a function for performing a calculation of truncating X may be used.

The resolution of each layer shown in FIG. 3 is an example when the resolution of the input data IM in the y direction is 36, and an actual resolution of each layer is appropriately changed according to the size of the input data IM.

The ClassVN layer 250 has n1 channels. In the example of FIG. 3, n1=3. In general, n1 is an integer equal to or greater than 1 and is the number of known classes that can be discriminated using the machine learning model 200. Usually, n1 is often set to 2 or more. Determination values Class 1 to Class 3 for the three known classes are output from the three channels of the ClassVN layer 250. Usually, a class having a largest value among the determination values Class 1 to Class 3 is used as a class discrimination result of the input data IM. In addition, when the largest value of the class among the determination values Class 1 to Class 3 is smaller than a predetermined threshold value, it may be determined that the class of the input data IM is unknown.

In the present disclosure, as described later, instead of using the determination values Class 1 to Class 3 of the ClassVN layer 250 serving as an output layer, the discrimination class can also be determined using a similarity by class calculated based on an output of a specific vector neuron layer.

In FIG. 3, a partial region Rn of each of the layers 210, 220, 230, 240, and 250 is further illustrated. A subscript “n” of the partial region Rn is a sign of each layer. For example, a partial region R210 indicates a partial region in the Cony layer 210. The “partial region Rn” is a region that is specified by a plane position (x, y) defined by a position of the first axis x and a position of the second axis y in each layer and includes a plurality of channels along the third axis z. The partial region Rn has dimensions of “Width”×“Height”×“Depth” corresponding to the first axis x, the second axis y, and the third axis z. In the present embodiment, the number of nodes included in one “partial region Rn” is “1×1×depth number”, that is, “1×1×the number of channels”.

As illustrated in FIG. 3, a feature spectrum Sp_ConvVN1 described later is calculated based on an output of the ConvVN1 layer 230 and is input to the similarity calculation unit 310. Similarly, a feature spectrum Sp_ConvVN2 is calculated based on an output of the ConvVN2 layer 240 and input to the similarity calculation unit 310. In another embodiment, a feature spectrum is also calculated based on an output of the ClassVN layer 250 and input to the similarity calculation unit 310. The similarity calculation unit 310 calculates a similarity Sm described later by using the feature spectra Sp_ConvVN1 and Sp_ConvVN and the known feature spectrum group KSp that is created in advance. The explanatory text creation unit 320 creates an explanatory text DS regarding the class discrimination result using this similarity Sm. As the similarity used to create the explanatory text, various similarities such as a local similarity and a similarity by class, which will be described later, can be used. In the embodiment described below, a method of creating an explanatory text mainly using the local similarity will be described.

In the present disclosure, the vector neuron layer used for calculation of the similarity is also referred to as a “specific layer”. One vector neuron layer or any number of vector neuron layers more than one vector neuron layer can be used as the specific layer. A configuration of the feature spectrum, a method for calculating a similarity using a feature spectrum, a method for creating an explanatory text using a similarity, and a method for determining a discrimination class will be described later.

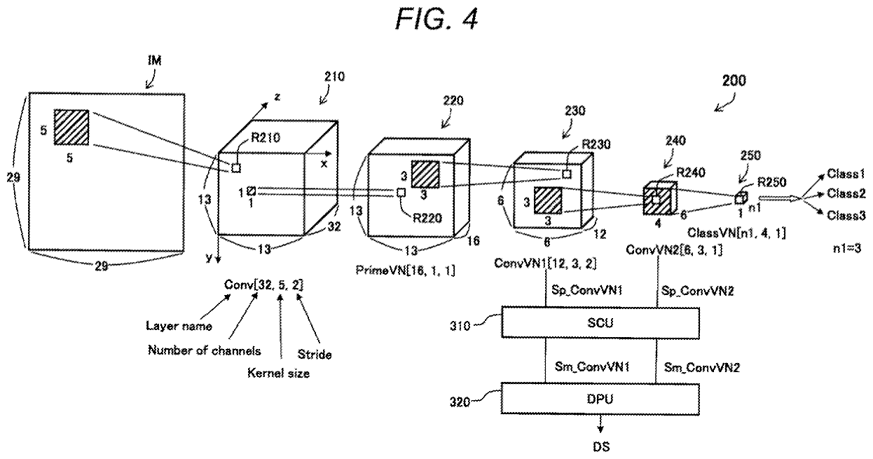

FIG. 4 is a diagram illustrating another configuration of the machine learning model 200. The machine learning model 200 is different from the machine learning model 200 of FIG. 3 using the input data of a one-dimensional array in that the input data IM is data of a two-dimensional array. The configurations of the layers 210 to 250 in FIG. 4 can be described as follows.

Description of Configuration of Each Layer
Conv layer 210: Conv[32, 5, 2]
PrimeVN layer 220: PrimeVN[16, 1, 1]
ConvVN1 layer 230: ConvVN1[12, 3, 2]
ConvVN2 layer 240: ConvVN2[6, 3, 1]
ClassVN layer 250: ClassVN[n1, 4, 1]
Vector dimension VD: VD=16

The machine learning model 200 shown in FIG. 4 can be used, for example, in the class discrimination system that performs the class discrimination of the discrimination target image. However, in the following description, the machine learning model 200 shown in FIG. 3 is used.

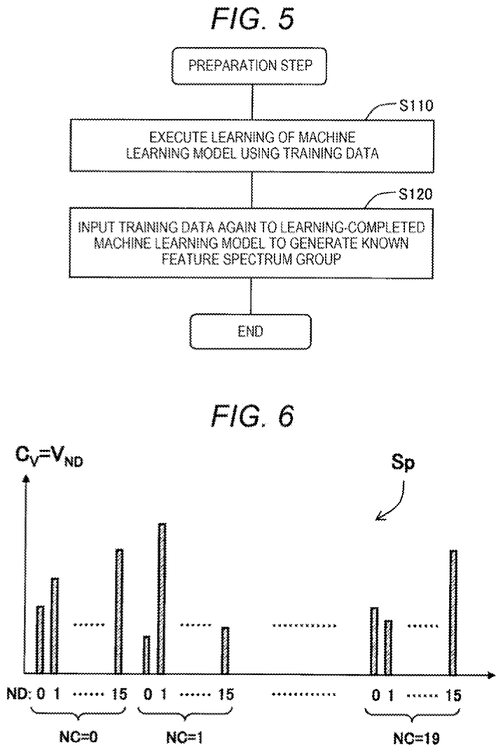

FIG. 5 is a flowchart showing a processing procedure of a preparation step of the machine learning model. This preparation step is, for example, a step executed by a manufacturer of the printer 10.

In step S110 of FIG. 5, the class discrimination processing unit 114 executes learning of the machine learning model 200 using a plurality of pieces of training data TD. A label is assigned in advance to each piece of training data TD. In the present embodiment, it is assumed that one of labels 1 to 3 is assigned to each piece of training data TD. These labels correspond to the three classes Class 1 to Class 3 of the machine learning model 200. In the present disclosure, the “label” and the “class” have the same meaning.

When the learning using the plurality of pieces of training data TD is completed, the learning-completed machine learning model 200 is stored in the memory 120. In step S120 of FIG. 5, the plurality of pieces of training data TD are input again to the learning-completed machine learning model 200 to generate the known feature spectrum group KSp. The known feature spectrum group KSp is a set of feature spectra described below.

FIG. 6 is a diagram illustrating a feature spectrum Sp obtained by inputting any piece of input data to the learning-completed machine learning model 200. Here, a feature spectrum Sp obtained based on the output of the ConvVN1 layer 230 will be described. A horizontal axis of FIG. 6 is a position of a vector element in each of output vectors of a plurality of nodes included in one partial region R230 of the ConvVN1 layer 230. The position of the vector element is represented by a combination of an element number ND and a channel number NC of the output vector at each node. In the present embodiment, since a vector dimension is 16, there are 16 element numbers ND of the output vector, that is, from 0 to 15. In addition, since the number of channels of the ConvVN1 layer 230 is 20, there are 20 channel numbers NC, that is, from 0 to 19. In other words, the feature spectrum Sp is obtained by arranging a plurality of element values of the output vector of each vector neuron included in the one partial region R230 over the plurality of channels along the third axis z.

A vertical axis of FIG. 6 shows a feature value C_{V} at each spectral position. In this example, the feature value C_{V} is a value V_{ND} of each element of the output vector. As the feature value C_{V}, a value obtained by multiplying the value V_{ND} of each element of the output vector by a normalization coefficient described later may be used, or the normalization coefficient may be used as it is. In the latter case, the number of feature values C_{V} included in the feature spectrum Sp is equal to the number of channels, which is 20. The normalization coefficient is a value corresponding to a vector length of the output vector of the node.

The number of feature spectra Sp, that is obtained based on the output of the ConvVN1 layer 230, with respect to one piece of input data is equal to the number of plane positions (x, y) of the ConvVN1 layer 230, that is, the number of the partial regions R230, and thus is six. Similarly, three feature spectra Sp are obtained based on the output of the ConvVN2 layer 240 for one piece of input data.

When the training data TD is input again to the learning-completed machine learning model 200, the similarity calculation unit 310 calculates the feature spectrum Sp shown in FIG. 6 and registers the feature spectrum Sp in the memory 120 as the known feature spectrum group KSp.

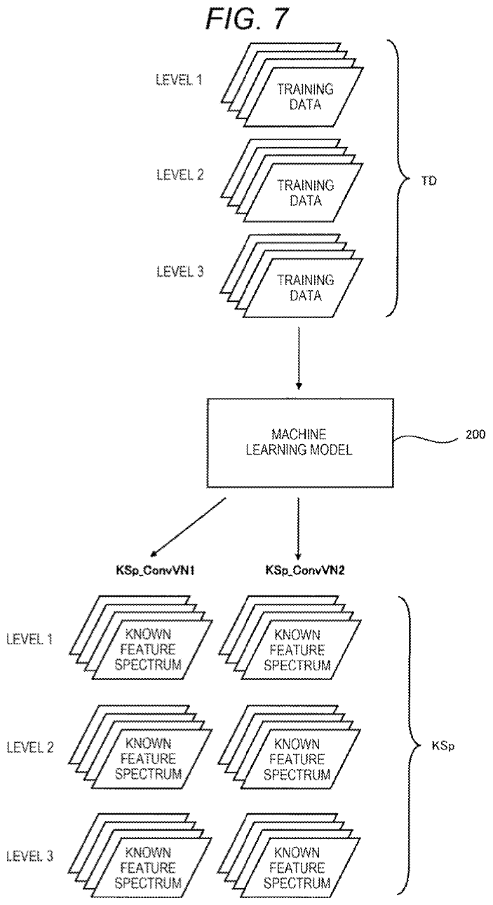

FIG. 7 is a diagram illustrating a state in which the known feature spectrum group KSp is created using the training data TD. In this example, by inputting the training data ID having labels of 1 to 3 to the leaning-completed machine learning model 200, feature spectra KSp_ConvVN1 and KSp_ConvVN2 each associated with the respective labels or classes are obtained based on outputs of two vector neuron layers, that is, outputs of the ConvVN1 layer 230 and the ConvVN2 layer 240. These feature spectra KSp_ConvVN1 and KSp_ConvVN2 are stored in the memory 120 as the known feature spectrum group KSp.

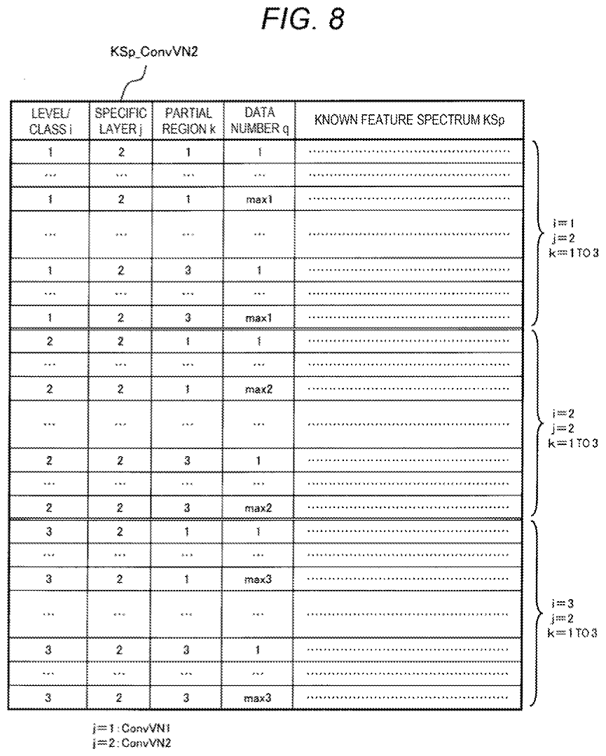

FIG. 8 is a diagram illustrating a configuration of the known feature spectrum group KSp. In this example, the known feature spectrum group KSp_ConvVN2 obtained based on the output of the ConvVN2 layer 240 is shown. The known feature spectrum group KSp_ConvVN1 obtained based on the output of the ConvVN1 layer 230 also has a similar configuration, and an illustration is omitted in FIG. 8. As the known feature spectrum group KSp, it is sufficient to register a feature spectrum group obtained based on an output of at least one vector neuron layer.

Records of the known feature spectrum group KSp_ConvVN2 include a parameter i indicating the order of the label or the class, a parameter j indicating the order of the specific layer, a parameter k indicating the order of the partial region Rn, a parameter q indicating a data number, and a known feature spectrum. KSp. The known feature spectrum. KSp is the same as the feature spectrum Sp of FIG. 6.

The parameter i of the class takes a value from 1 to 3, which is the same as the label. The parameter j of the specific layer takes a value from 1 to 2, and indicates which one of the two specific layers 230 and 240 is the specific layer. The parameter k of the partial region Rn takes a value indicating which one among a plurality of partial regions Rn included in each specific layer is the partial region Rn, that is, a value indicating which plane position (x, y) the partial region Rn is at. Since the number of partial regions R240 of the ConvVN2 layer 240 is 3, k=1 to 3. The parameter q of the data number indicates the number of the training data to which the same label is attached, and takes a value from 1 to max1 for a class 1, from 1 to max2 for a class 2, and from 1 to max3 for a class 3.

The plurality of pieces of training data TD used in step S120 is not necessary to be the same as the plurality of pieces of training data TD used in step S110. However, if a part or all of the plurality of pieces of training data TD used in step S110 are also used in step S120, there is an advantage that it is not necessary to prepare new training data.

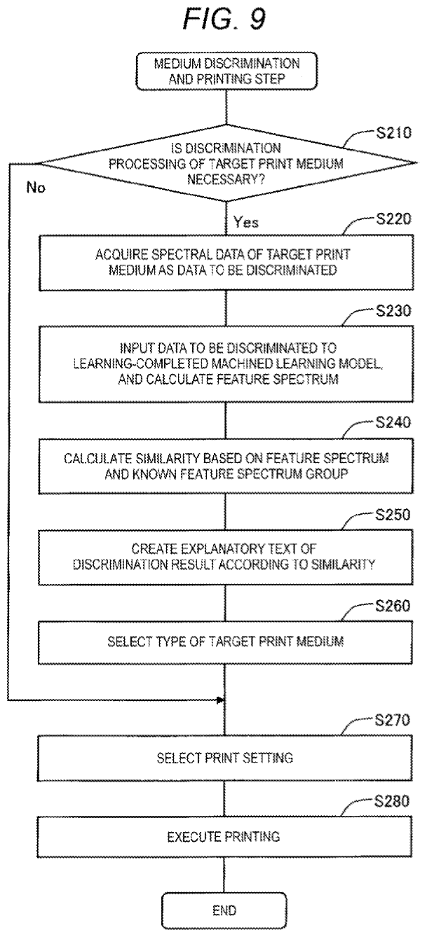

FIG. 9 is a flowchart showing a processing procedure of a medium discrimination and printing step using the learning-completed machine learning model. The medium discrimination and printing step is executed by a user who uses the printer 10, for example.

In step S210, the user instructs the class discrimination processing unit 114 whether the class discrimination processing is necessary for a target print medium which is a print medium to be processed. When the user knows a type of the target print medium, the user may also issue an instruction that the class discrimination processing is necessary for confirmation. When the class discrimination processing is not necessary, the process proceeds to step S270, in which the user selects the print setting suitable for the target print medium, and in step S280, the print processing unit 112 causes the printer 10 to execute printing using the target print medium. On the other hand, when the type of the target print medium is unknown and the class discrimination processing is necessary, the process proceeds to step S220.

In step S220, the spectrometer 30 performs a spectral measurement of the target print medium, and thereby the class discrimination processing unit 114 acquires the spectral data. The spectral data is used as the data to be discriminated to be input to the machine learning model 200.

In step S230, the class discrimination processing unit 114 inputs the data to be discriminated to the learning-completed machine learning model 200, and calculates the feature spectrum Sp. In step S240, the similarity calculation unit 310 calculates a similarity based on the feature spectrum Sp, which is obtained in response to the input of the data to be discriminated, and the registered known feature spectrum group KSp.

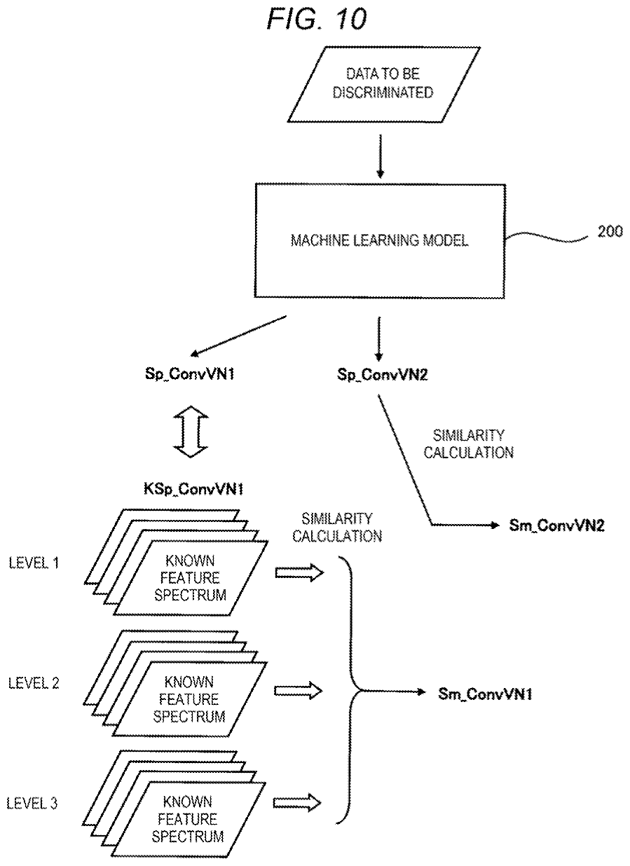

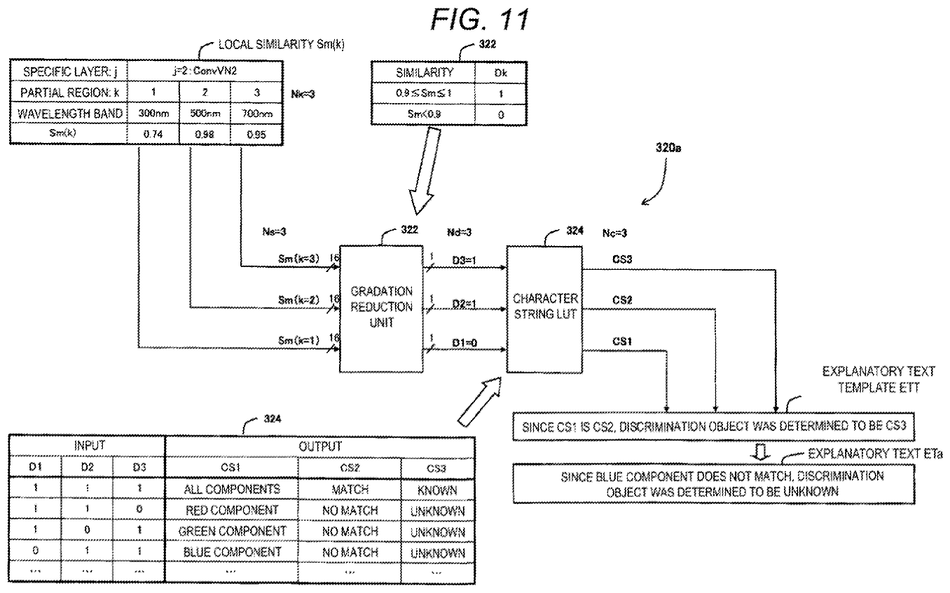

FIG. 10 is a diagram illustrating a state in which the similarity for the data to be discriminated is obtained. When the data to be discriminated is input to the machine learning model 200, the class discrimination processing unit 114 calculates the feature spectra Sp_ConvVN1 and Sp_ConvVN2 respectively based on the outputs of the ConvVN1 layer 230 and the ConvVN2 layer 240. The similarity calculation unit 310 calculates a similarity Sm_ConvVN1 by using the known feature spectrum group KSp_ConvVN1 and the feature spectrum Sp_ConvVN1 which is obtained based on the output of the ConvVN1 layer 230. A specific method of calculating the similarity Sm will be described later. A similarity Sm_ConvVN2 is calculated in the same manner for the ConvVN2 layer 240.

The similarity Sm can be calculated, for example, according to the following equation.

Sm(i,j,k)=max[G{Sp(j,k),KSp(i,j,k=all,q=all)}] (2)

Here, i is a parameter indicating the class, j is a parameter indicating the specific layer, k is a parameter indicating the partial region Rn, q is a parameter indicating the data number, G{a, b} is a function for obtaining the similarity between a and b, Sp(j, k) is a feature spectrum obtained based on an output of a specific partial region k of a specific layer j according to the data to be discriminated, KSp(i, j, k=all, q=all) is known feature spectra of all data numbers q in all the partial regions k of the specific layer j associated with the class i in the known feature spectrum group KSp shown in FIG. 8, and max[X] is a logical calculation that takes a maximum value of values of X.

The a of the function G{a, b} for obtaining the similarity is one value or a set, b is a set, and there are a plurality of return values. As the function G{a, b}, for example, an equation for obtaining a cosine similarity or an equation for obtaining a similarity corresponding to a distance can be used.

Since this similarity Sm is obtained for each partial region, the similarity Sm is also referred to as “local similarity Sm” below. The local similarity Sm (i, j, k) depends on the class i, the specific layer j, and the partial region k, but in the following description, the local similarity Sm(i, j, k) may be described as “local similarity Sm (k)” by omitting the parameter i indicating the class and the parameter j indicating the specific layer.

It is not necessary to generate both the similarity Sm_ConvVN1 and the similarity Sm_ConvVN2 by respectively using the two vector neuron layers 230 and 240, but it is preferable to calculate the similarity Sm using one or more of these vector neuron layers. As described above, in the present disclosure, the vector neuron layer used for the calculation of the similarity is referred to as the “specific layer”.

In step S250, the explanatory text creation unit 320 creates the explanatory text according to the similarity obtained in step S240.

FIG. 11 is a diagram illustrating a processing of creating the explanatory text in the first embodiment. An explanatory text creation unit 320a of the first embodiment includes a gradation reduction unit 322 and a character string lookup table 324. The reference numeral “a” at the end of the explanatory text creation unit 320a indicates that the explanatory text creation unit 320a is that of the first embodiment. The character string lookup table 324 is the same as the character string lookup table CT shown in FIG. 2.

FIG. 11 shows a state in which the explanatory text is created using the local similarities Sm obtained based on the three partial regions of the ConvVN2 layer 240. As shown in an upper left part of FIG. 11, the three partial regions of the ConvVN2 layer 240 correspond to three wavelength bands respectively having central wavelengths of 300 nm, 500 nm, and 700 nm. The gradation reduction unit 322 reduces the number of gradations (the number of discrete values that can be taken within a range from a maximum value to a minimum value) of the three local similarities Sm(k), thereby creating three pieces of table input data D1 to D3. Specifically, the gradation reduction unit 322 binarizes (quantizes) the local similarity Sm(k) using a threshold value created in advance. In this example, the local similarity Sm(k) is 16-bit data and the number of gradations is 2¹⁶, and the table input data D1 to D3 are 1-bit data and the number of gradations is 2. However, the number of gradations of the table input data D1 to D3 may be 3 or more and can be set to any number of 2 or more.

The character string lookup table 324 outputs character strings CS1 to CS3 in response to inputs of the table input data D1 to D3. An example of the character strings CS1 to CS3 corresponding to a combination of the table input data D1 to D3 is shown in a lower left part of FIG. 11. The explanatory text creation unit 320 creates an explanatory text ETa by applying the three character strings CS1 to CS3 to an explanatory text template ETa having three character string frames corresponding to the three character strings CS1 to CS3. In the example of FIG. 11, the local similarities Sm in the two wavelength bands of 500 nm and 700 nm are equal to or greater than the threshold value, but the local similarity Sm in the wavelength band of 300 nm is smaller than the threshold value, and thus an appropriate explanatory text ETa corresponding to the local similarity Sm is created. As described above, in the present embodiment, the explanatory text ETa corresponding to the similarity Sm can be created by using the character string lookup table 322 and the explanatory text template ETa. The explanatory text ETa created in this way is displayed on the display unit 150.

The various numbers used in FIG. 11 are as follows.

(1) The number Nk of partial regions included in the specific layer

Nk=3 in the example of FIG. 11

(2) The number Ns of local similarities Sm used to create the explanatory text

Ns=Nk=3 in the example of FIG. 11, but Ns can be set to any number equal to or smaller than Nk. Ns can be set to 1 or greater, but is preferably 2 or greater. An example of Ns<Nk will be described in a third embodiment.

(3) The number Nd of pieces of table input data Dk

Nd=Ns=3 in the example of FIG. 11, but Nd can be set to any number equal to or greater than 1 and equal to or smaller than Ns. Nd can be set to 1 or greater, but is preferably 2 or greater. An example of Nd<Ns will be described in a second embodiment.

(4) The number Nc of character strings output from the character string lookup table 324

Nc=3 in the example of FIG. 11, but Nc can be set to any number equal to or greater than 1.

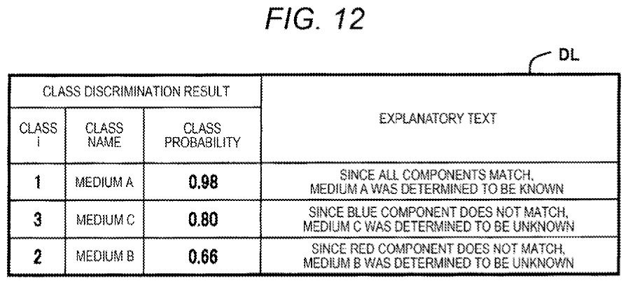

FIG. 12 shows an example of the explanatory text displayed on the display unit 150. In this example, a discrimination result list DL in which the class discrimination result and the explanatory text are arranged for each of the plurality of classes is displayed on the display unit 150. As the class discrimination result, the parameter i indicating the class, a class name, and a class probability, which is a probability that the data to be discriminated corresponds to the class, are displayed. As the class probability, for example, a determination value output from the output layer of the machine learning model 200 can be used. In addition, when the class discrimination is performed using the similarity by class described later, the similarity by class may be used as the class probability. Further, a part of the class discrimination result may be omitted. In addition, an activation value in the ClassVN layer 250 of the machine learning model 200 may be used as the class probability, and an explanatory text may be created based on the activation value. Specifically, for example, an explanatory text such as “since Activation=0.99, reliability of the discrimination result is high” can be created. Further, the similarity calculated based on the output of the ClassVN layer 250 may be used as the class probability, and the explanatory text may be created from the similarity. Specifically, for example, an explanatory text such as “known data because ClassVN similarity=0.99” can be created.

As in the example of FIG. 12, if the discrimination result list DL in which the class discrimination result and the explanatory text are arranged for each of the plurality of classes is displayed on the display unit 150, the user can know a basis of the class discrimination result related to each class. Further, the discrimination result list DL does not need to include information on all classes of the plurality of classes that can be discriminated by the machine learning model 200, and preferably includes information on at least two or more classes. In addition, instead of displaying the discrimination result list DL, an explanatory text for one class discriminated by the machine learning model 200 may be displayed.

In step S260, the user selects the class of the target print medium, that is, the type of the target print medium with reference to the explanatory text created in step S250 and instructs the print processing unit 112 of the selected type. In step S270, the print processing unit 112 selects the print setting by referring to the print setting table PST according to the type of the target print medium. In step S280, the print processing unit 112 performs the printing according to the print setting. According to the procedure of FIG. 9, even when the type of the target print medium is unknown, the type of the target print medium can be discriminated using the machine learning model 200, so that the printing can be performed using the print setting suitable for the type.

As described above, in the first embodiment, since the explanatory text of the class discrimination result is created and output using the similarity for the feature vector, the user can know the basis of the class discrimination result.

### B. Second Embodiment

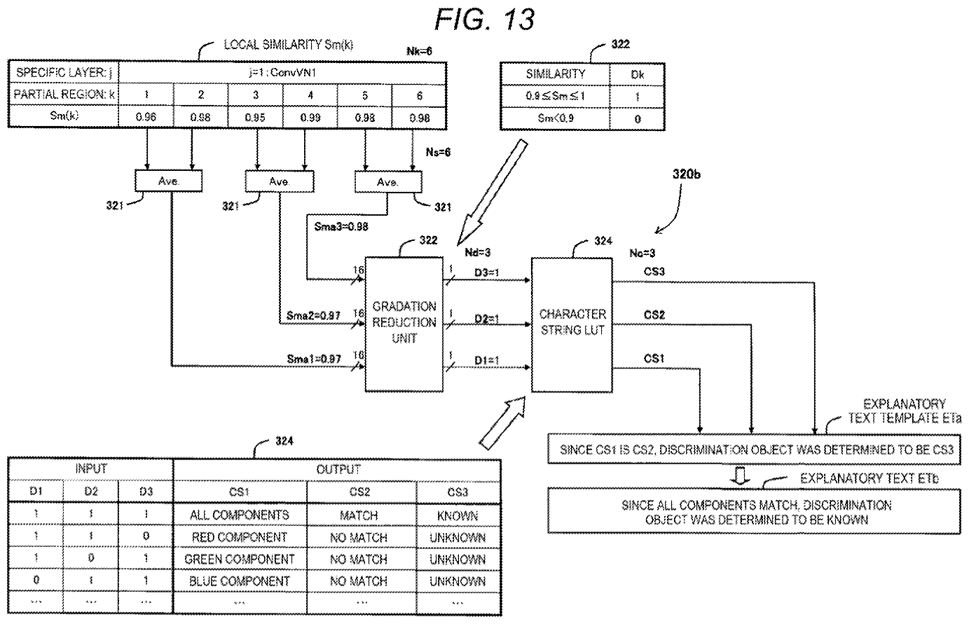

FIG. 13 is a diagram illustrating a processing of creating an explanatory text in a second embodiment. An explanatory text creation unit 320b of the second embodiment includes an average value calculation unit 321 in addition to the gradation reduction unit 322 and the character string lookup table 324. The configuration of the device shown in FIGS. 1 and 2 and the procedure of the processing shown in FIGS. 5 and 9 are substantially the same as those of the first embodiment.

FIG. 13 shows a state in which an explanatory text is created using local similarities Sm obtained based on six partial regions of the ConvVN1 layer 230. The average value calculation unit 321 groups the six local similarities Sm into three groups and averages the local similarities Sm belonging to each group to obtain three average similarities Sma1 to Sma3. The number of average similarities is the same as the number Nd of pieces of table input data Dk. These three average similarities Sma1 to Sma3 are similarities for three wavelength bands respectively having central wavelengths of 300 nm, 500 nm, and 700 nm, similarly to the three local similarities Sm shown in FIG. 11 in the first embodiment. The gradation reduction unit 322 creates the table input data Dk by reducing the number of gradations of the average similarities Sma1 to Sma3. Since the subsequent processing is the same as that of the first embodiment shown in FIG. 11, a detailed description thereof will be omitted. In the example of FIG. 13, an explanatory text ETb that “since all components match, discrimination object was determined to be known” is created.

In the example of FIG. 13, the average similarity Sma is created by obtaining an average value of the local similarities Sm in two adjacent partial regions. However, in general, the average similarities Sma can be obtained by grouping Ns local similarities Sm used to create an explanatory text into Nd groups and averaging the local similarities Sm of each group. In this case, Nd is a value smaller than Ns.

As described above, in the second embodiment, since Nd pieces of table input data are created by obtaining Nd average similarities based on the Ns local similarities and reducing the number of gradations of the Nd average similarities, the explanatory text can be created according to the average similarities obtained by averaging the local similarities.

In the above description, the average similarity Sma is obtained for each group of the local similarities, but a representative value other than the average similarity may be obtained. As a representative value, it is possible to use a maximum value or a minimum value in addition to the average value. In other words, in the second embodiment, the Nd pieces of table input data may be created by obtaining Nd representative similarities based on the Ns local similarities and reducing the number of gradations of the Nd representative similarities. In this way, the explanatory text can be created according to the representative similarities.

### C. Third Embodiment

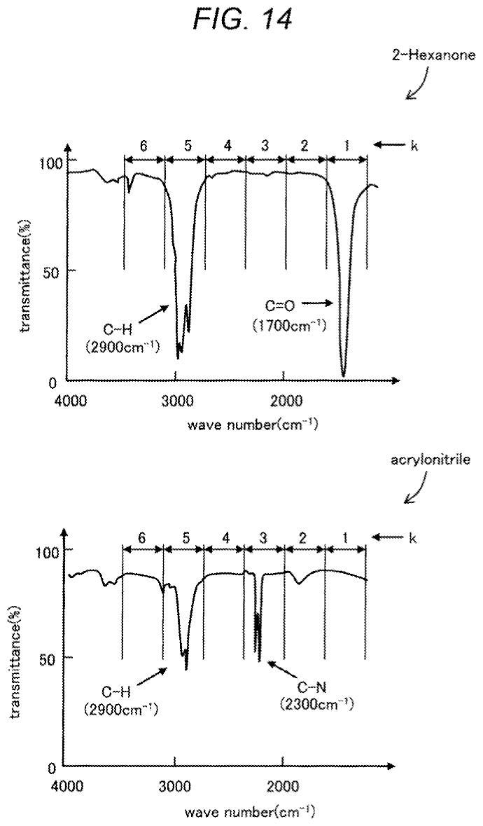

FIG. 14 is a diagram illustrating infrared absorption spectra of 2-hexanone and acrylonitrile serving as discrimination objects of a class discrimination processing in a third embodiment. A horizontal axis of each graph is a wave number, and a vertical axis is an absorption rate. In the third embodiment, it is assumed that it is to determine whether the discrimination object is 2-hexanone in a state where it is known that the discrimination object is either 2-hexanone or acrylonitrile. In this case, the number of classes of an output layer of the machine learning model 200 shown in FIG. 3 is 1.

An infrared absorption spectrum of 2-hexanone includes an absorption peak due to C—H bond in a 2900 cm⁻¹ wavenumber band and an absorption peak due to C=O bond in a 1700 cm⁻¹ wavenumber band. On the other hand, an infrared absorption spectrum of acrylonitrile includes an absorption peak due to C—H bond in a 2900 cm⁻¹ wavenumber band and an absorption peak due to C—N bond in a 2300 cm⁻¹ wavenumber band. Each graph shows a relation between the wavenumber band and the parameter k that distinguishes the six partial regions of the ConvVN1 layer 230. As described below, in the third embodiment, an explanatory text is created using a part of the local similarities Sm of the six partial regions.

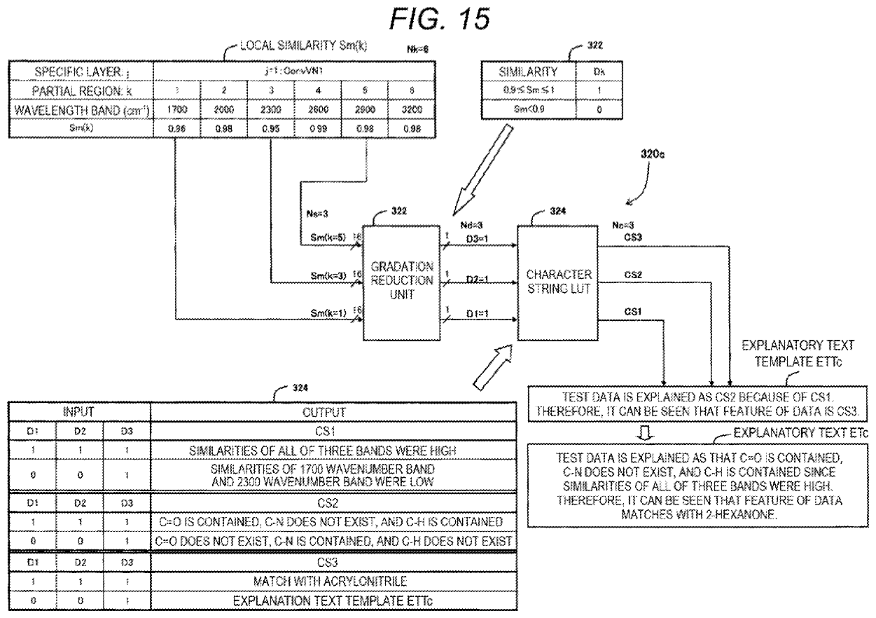

FIG. 15 is a diagram illustrating a processing of creating the explanatory text according to the third embodiment. An explanatory text creation unit 320c of the third embodiment is the same as that of the first embodiment shown in FIG. 11 in that the explanatory text creation unit 320c includes the gradation reduction unit 322 and the character string lookup table 324. However, a character string stored in the character string lookup table 324 is different from that of the first embodiment. The information processing device 20 shown in FIG. 2 can also be used in the third embodiment, except that the printer 10 and the print processing unit 112 are not used. In addition, the procedure of the processing shown in FIG. 5 can be substantially the same as that of the first embodiment. Further, in the processing shown in FIG. 9, the “target print medium” is replaced with the “discrimination object”, and a class discrimination in the third embodiment can be performed by executing the processing of steps S250 to S270.

In the example of FIG. 15, an explanatory text is created using three local similarities Sm(k=1), Sm(k=3), and Sm(k=5) selected in advance from the local similarities Sm obtained based on the six partial regions of the ConvVN1 layer 230. These three local similarities Sm(k=1), Sm(k=3), and Sm(k=5) respectively correspond to the 1700 cm⁻¹ wavenumber band, the 2300 cm⁻¹ wavenumber band, and the 2900 cm⁻¹ wavenumber band shown in FIG. 14. The number of selected local similarities Sm is the same as the number Nd of pieces of table input data Dk.

Similar to the first embodiment, the gradation reduction unit 322 creates the table input data Dk by reducing the number of gradations of the local similarities. The character string lookup table 324 outputs the three character strings CS1 to CS3 in response to the input of table input data D1 to D3. The explanatory text creation unit 320c creates an explanatory text ETc by applying the three character strings CS1 to CS3 to a explanatory text template ETc having three character string frames corresponding to the three character strings CS1 to CS3. As can be seen by comparing FIGS. 11 and 15, registered contents of the character string lookup table 324 and contents of the explanatory text template ETc are different from those of the first embodiment. In the example of FIG. 15, since all of the three local similarities Sm used to create the explanatory text are equal to or greater than the threshold value, an appropriate explanatory text ETc indicating that the discrimination object corresponds to 2-hexanone is created.

The explanatory text may be created by using a part of a total of 12 individual similarities including six individual similarities calculated for hexanone and six individual similarities calculated for acrylonitrile. For example, it is also possible to create an explanatory text that “since there is C=O and there is no C—N, hexanone is discriminated” or an explanatory text that “since there is no C=O and there is C—N, acrylonitrile is discriminated”.

As described above, in the third embodiment, since the table input data is created based on the local similarities with respect to a part of partial regions among a plurality of partial regions included in a specific layer, the explanatory text can be created using the local similarity suitable for the description of a discrimination result.

In the various embodiments described above, the character string is created using the character string lookup table, but the character string or the explanatory text may be created using a decision tree instead of the character string lookup table.

### D. Method of Calculating Similarity

As a method of calculating the local similarity Sm as described above, for example, either of the following two methods can be adopted.

(1) A first calculation method M1 for obtaining the local similarity Sm without considering correspondence between partial regions Rn in the feature spectrum Sp and the known feature spectrum group KSp

(2) A second calculation method M2 for obtaining the local similarity Sm between the partial regions Rn corresponding to the feature spectrum. Sp and the known feature spectrum group KSp

Hereinafter, a method of calculating the similarity based on the output of the ConvVN1 layer 230 according to the two calculation methods M1 and M2 will be sequentially described.

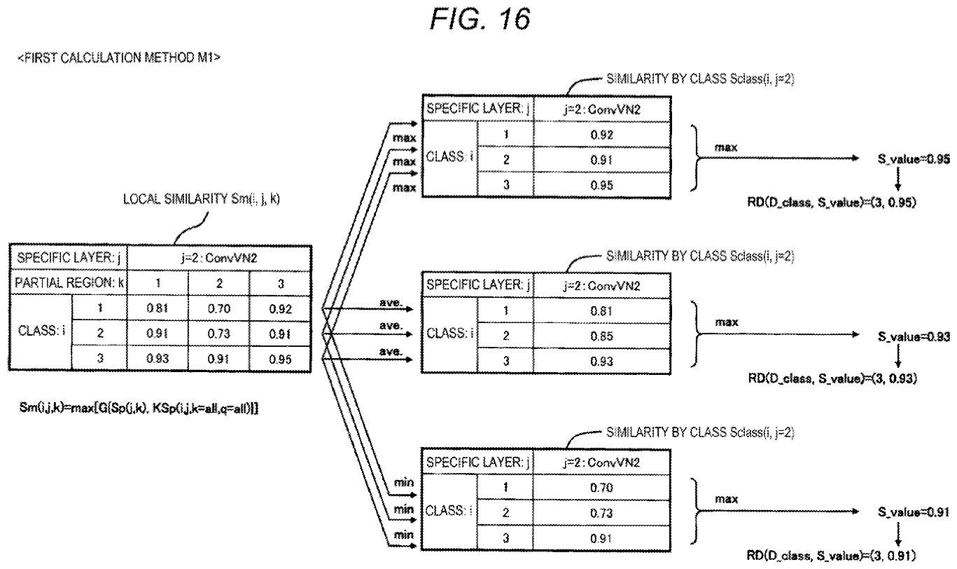

FIG. 16 is a diagram illustrating the first calculation method M1 of the similarity. Here, a case is shown where the local similarity Sm(i, j, k) indicating the similarity to each class i is calculated for each partial region k based on the output of the ConvVN1 layer 230 which is a specific layer.

In the first calculation method M1, the local similarity Sm(i, j, k) is calculated using Equation (2) reprinted below.

Sm(i,j,k)=max[G{Sp(j,k),KSp(i,j,k=all,q=all)}] (2)

Here, i is a parameter indicating the class, j is a parameter indicating the specific layer, k is a parameter indicating the partial region Rn, q is a parameter indicating the data number, G{a, b} is a function for obtaining the similarity between a and b, Sp(j, k) is the feature spectrum obtained based on the output of the specific partial region k of the specific layer j according to the data to be discriminated, KSp(i, j, k=all, q=all) is the known feature spectrum of all data numbers q in all the partial regions k of the specific layer j associated with the class i in the known feature spectrum group KSp shown in FIG. 8, and max[X] is the logical calculation that takes the maximum value of values of X.

The a of the function G{a, b} for obtaining the similarity is one value or a set, b is a set, and there are a plurality of return values. As the function G{a, b}, for example, an equation for obtaining a cosine similarity or an equation for obtaining a similarity corresponding to a distance can be used.

A right side of FIG. 16 shows a state where a similarity by class Sclass(i, j) is calculated based on these local similarities Sm(i, j, k). Three types of class-specific similarities Sclass(i, j) are obtained for each class i by taking a maximum value, an average value, or a minimum value of the local similarities Sm(i, j, k) for the plurality of partial regions k. Which calculation of the maximum value, the average value, or the minimum value is to be used depends on a purpose of use of a class discrimination processing. For example, when the purpose is to discriminate an object using a natural image, it is preferable to obtain the similarity by class Sclass (i, j) for each class i by taking the maximum value of the local similarities Sm(i, j, k). In addition, when the purpose is to discriminate the type of a print medium or the purpose is to determine a quality of an industrial product using an image of the industrial product, it is preferable to obtain the similarity by class Sclass (i, j) for each class i by taking the minimum value of the local similarities Sm(i, j, k). In addition, a case is also conceived where it is preferable to obtain the similarity by class Sclass(i, j) for each class i by taking an average value of the local similarities Sm(i, j, k). Which one of these three types of calculation is to be used is set in advance by the user experimentally or empirically.

In the example of FIG. 16, a final discrimination result RD_ConvVN1 is further determined based on the similarity by class Sclass(i, j). The discrimination result RD_ConvVN1 can be expressed in a format including a discrimination class D_class and a similarity value S_value corresponding to the discrimination class D_class. The similarity value S_value is obtained by taking the maximum value among similarity values for three classes 1 to 3 in the similarity by class Sclass (i, j). The discrimination class D_class is a class having a maximum similarity value in the similarity by class Sclass (i, j).

As described above, in the first calculation method M1 of the similarity,

(1) the local similarity Sm(i, j, k) which is the similarity between the feature spectrum Sp, which is obtained based on the output of the specific partial region k of the specific layer j according to the data to be discriminated, and all the known feature spectra KSp associated with the specific layer j and each class i is obtained,

(2) the similarity by class Sclass (i, j) is obtained for each class i by taking the maximum value, the average value, or the minimum value of the local similarity Sm(i, j, k) for the plurality of partial regions k,

(3) the maximum value of the values of the similarity by class Sclass (i, j) for the plurality of classes i is obtained as the similarity value S_value between the feature spectrum Sp and the known feature spectrum group KSp, and

(4) the class associated with the maximum similarity value S_value over the plurality of classes is determined as the discrimination class D_class.

According to the first calculation method M1, the similarities Sm(i, j, k) and Sclass(i, j), and the discrimination result can be obtained by relatively simple calculation and a relatively simple procedure.

As the discrimination result obtained using the machine learning model 200, the discrimination class D_class determined according to the similarity by class Sclass(i, j) may be used, or the discrimination class determined based on the determination value obtained from the output layer of the machine learning model 200 may be used. In the latter case, a processing after the calculation of the similarity by class Sclass (i, j) may be omitted. These points are similar to those in the second calculation method M2 described below.

The explanatory text creation unit 320 may create the explanatory text for the discrimination result according to the similarity by class Sclass (i, j). The explanatory text corresponding to the similarity by class Sclass (i, j) is, for example, “since similarity to class 1 is 98%, discrimination object was determined to be known”.

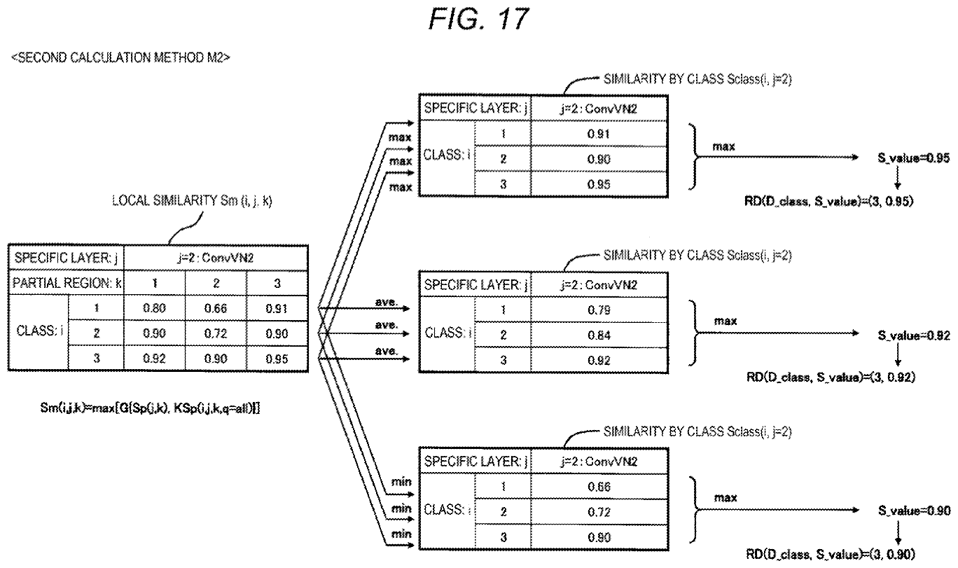

FIG. 17 is a diagram illustrating the second calculation method M2 of the similarity. In the second calculation method M2, the local similarity Sm(i, j, k) is calculated using the following equation instead of Equation (2).

Sm(i,j,k)=max[G{Sp(j,k),KSp(i,j,k,q=all)}] (3)

Here, KSp(i, j, k, q=all) is the known feature spectrum of all the data numbers q in the specific partial region k of the specific layer j associated with the class i in the known feature spectrum group KSp shown in FIG. 8.

In the first calculation method M1 described above, the known feature spectrum KSp(i, j, k=all, q=all) in all the partial regions k of the specific layer j is used, whereas in the second calculation method M2, only the known feature spectrum KSp(i, j, k, q=all) for the same partial region k as the partial region k of the feature spectrum Sp(j, k) is used. Other parts in the second calculation method M2 are the same as those in the first calculation method M1.

In the second calculation method M2 of the similarity by class,

(1) the local similarity Sm(i, j, k) which is the similarity between the feature spectrum Sp, which is obtained based on the output of the specific partial region k of the specific layer j according to the data to be discriminated, and all the known feature spectra KSp associated with the specific partial region k of the specific layer j and each class i is obtained,

(2) the similarity by class Sclass (i, j) is obtained for each class i by taking the maximum value, the average value, or the minimum value of the local similarity Sm(i, j, k) for the plurality of partial regions k,

(3) the maximum value of the values of the similarity by class Sclass (i, j) for the plurality of classes i is obtained as the similarity value S_value between the feature spectrum Sp and the known feature spectrum group KSp, and

(4) the class associated with the maximum similarity value S_value over the plurality of classes is determined as the discrimination class D_class.

According to the second calculation method M2, the similarities Sm(i, j, k) and Sclass(i, j), and the discrimination result can also be obtained by relatively simple calculation and a relatively simple procedure.

Both the two calculation methods M1 and M2 described above are methods of determining the discrimination class by calculating the local similarity and the similarity by class for each specific layer i. As described above, in the present embodiment, one or more of the plurality of vector neuron layers 230 and 240 shown in FIG. 3 can be used as specific layers to calculate the local similarity and the similarity by class, and the class of the data to be discriminated can be determined based on the similarity by class. When a plurality of specific layers are used, for example, the following determination method of the discrimination class can be adopted.

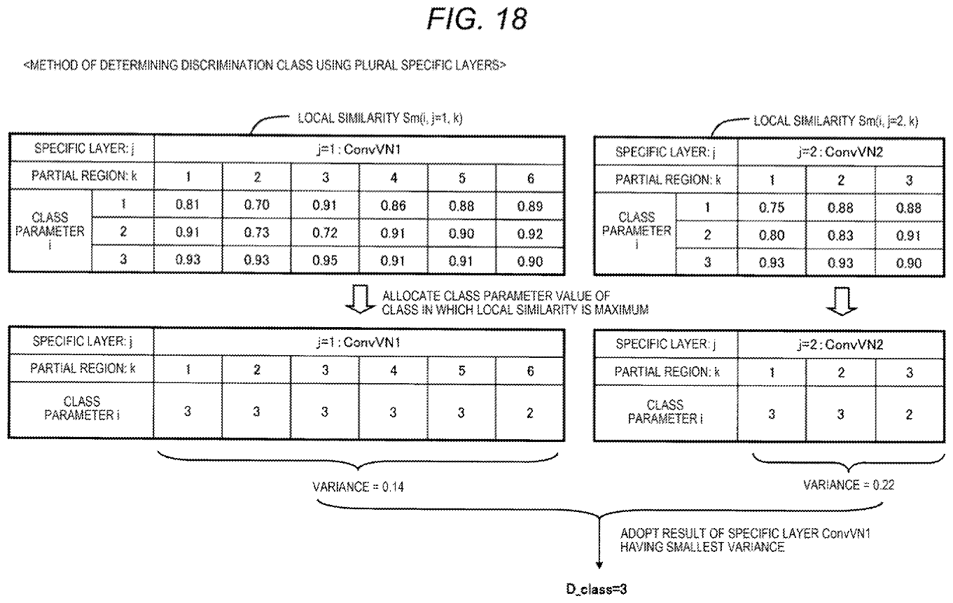

FIG. 18 is a diagram illustrating the determination method of the discrimination class using a plurality of specific layers. In this determination method, the discrimination class is determined using a specific layer showing a most statistically significant discrimination result among the plurality of specific layers. In the example of FIG. 18, the ConvVN1 layer 230 and the ConvVN2 layer 240 are used as the specific layers. First, a processing of determining, for each partial region k of the ConvVN1 layer 230, a class in which the local similarity Sm(i, j, k) has a maximum value, and allocating a class parameter value i of the class to each partial region k is executed. The class parameter value i is a value indicating the order of the plurality of classes. The class parameter value i takes, for example, continuous integers. In the present embodiment, the class parameter value i and the class i are the same. Similarly, for the ConvVN2 layer 240, the processing of determining the class in which the local similarity Sm(i, j, k) has the maximum value, and allocating the class parameter value i of the class to each partial region k is executed.

In addition, in the second determination method MM2, when there is no difference in the local similarity Sm between the classes for each partial region k, that is, when an error or variance over the plurality of classes related to the local similarity Sm of a certain partial region k is within a threshold value, the class parameter value may not be allocated to the partial region k. When a variance of the class parameter values is obtained, a variance is obtained by excluding the partial region k to which the class parameter value is not allocated. Accordingly, since the variance can be obtained only in a characteristic portion, the class discrimination can be performed with the higher accuracy.

In the determination method, further, a variance of a distribution of the class parameter values i in a plurality of partial regions kin each specific layer is calculated. This variance is a value of a statistical variance for the class parameter value i. In the example of FIG. 18, a variance of the ConvVN1 layer 230 is 0.14, and a variance of the ConvVN2 layer 240 is 0.22. In these specific layers 230 and 240, since it is expected that the larger a deviation of the distribution of the class parameter value i is, the more clear the discrimination result is, the class discrimination result for the specific layer having a low variance is adopted. In other words, the class of the data to be discriminated is discriminated using a similarity by class obtained for a specific layer having a smallest variance among the plurality of specific layers. According to this determination method, the class discrimination can be performed with the higher accuracy using the plurality of specific layers. As described above, when the class discrimination result is determined using the class-specific similarities obtained from the plurality of specific layers, it is preferable to use the local similarity of the specific layer from which the class discrimination result is obtained as the local similarity used to create the explanatory text in the above first to third embodiments.

### E. Calculation Method of Output Vector of Each Layer of Machine Learning Model

The calculation method of the output of each layer in the machine learning model 200 shown in FIG. 3 is as follows. The same applies to the machine learning model 200 shown in FIG. 4 except for the values of individual parameters.

Each node of the PrimeVN layer 220 regards scalar outputs of 1×1×32 nodes of the Cony layer 210 as a 32-dimensional vector, and a vector output of the node is obtained by multiplying this vector by a transformation matrix. The transformation matrix is an element of a kernel having a surface size of 1×1 and is updated by the learning of the machine learning model 200. The processings of the Cony layer 210 and the PrimeVN layer 220 can be integrated to form one primary vector neuron layer.

When the PrimeVN layer 220 is referred to as a “lower layer L” and the ConvVN1 layer 230 adjacent to an upper side of the PrimeVN layer 220 is referred to as an “upper layer L+1”, an output of each node of the upper layer L+1 is determined using the following equations.

$${ν}_{i j} = {W}_{i j}^{L} {M}_{i}^{L} \qquad ( E 1 )$$

$${u}_{j} = {\sum }_{i} {ν}_{i j} \qquad ( E 2 )$$

$${a}_{j} = F ( ‖ {u}_{j} ‖ ) \qquad ( E 3 )$$

$${M}_{j}^{L + 1} = {a}_{j} \times \frac{1}{‖ {u}_{j} ‖} {u}_{j} \qquad ( E 4 )$$

Here, M^{L}ᵢ is an output vector of an i-th node in the lower layer L, M^{L+1}ᵢ is an output vector of a j-th node in the upper layer L+1, vᵢⱼ is a prediction vector of an output vector M^{L+1}ⱼ, M^{L}ᵢⱼ is a prediction matrix for calculating the prediction vector vᵢ based on the output vector M^{L}ᵢ of the lower layer L, uⱼ is a sum of the prediction vector vᵢⱼ, that is, a sum vector, which is a linear combination, aⱼ is an activation value which is a normalization coefficient obtained by normalizing a norm |uⱼ| of the sum vector uⱼ, and F (X) is a normalization function for normalizing X.

As the normalization function F(X) for example, the following Equation (E3a) or (E3b) can be used.

$${a}_{j} = F ( ‖ {u}_{j} ‖ ) = softmax ( ‖ {u}_{j} ‖ ) = \frac{exp ( β ‖ {u}_{j} ‖ )}{{Σ}_{k} exp ( β ‖ {u}_{k} ‖ )} \qquad ( E 3 a )$$

$${a}_{\dot{j}} = F ( ‖ {u}_{j} ‖ ) = \frac{‖ {u}_{j} ‖}{{Σ}_{k} ‖ {u}_{k} ‖} \qquad ( E3b )$$

Here, k is an ordinal number for all the nodes in the upper layer L+1, and β, is an adjustment parameter which is any positive coefficient, for example, β=1.

In Equation (E3a), the activation value aⱼ is obtained by normalizing, with a softmax function, the norm |uⱼ| of of the sum vector uⱼ for all the nodes in the upper layer L+1. On the other hand, in Equation (E3b), the activation value aⱼ is obtained by dividing the norm |uⱼ| of the sum vector uⱼ by a sum of norms |uⱼ| for all the nodes of the upper layer L+1. As the normalization function F(X), a function other than Equations (E3a) and (E3b) may be used.

The ordinal number i of Equation (E2) is conveniently assigned to the node of the lower layer L used to determine the output vector M^{L+1}ⱼ of the j-th node in the upper layer L+1, and takes a value from 1 to n. In addition, an integer n is the number of nodes in the lower layer L used to determine the output vector M^{L+1}ⱼ of the j-th node in the upper layer L+1. Therefore, the integer n is given by the following equation.

n=Nk×Nc (E5)

Here, Nk is the surface size of the kernel, and Nc is the number of channels of the PrimeVN layer 220 which is the lower layer. In the example of FIG. 3, since Nk=5 and Nc=26, n=130.

One kernel used to obtain the output vector of the ConvVN1 layer 230 has 1×5×26=130 elements with a kernel size of 1×5 as the surface size and the number of channels of 26 in the lower layer as the depth, and each of these elements is the prediction matrix W^{L}ᵢⱼ In order to generate the output vectors of 20 channels of the ConvVN1 layer 230, 20 sets of these kernels are necessary. Therefore, the number of prediction matrices W^{L}ᵢⱼ of the kernels used to obtain the output vector of the ConvVN1 layer 230 is 130×20=2600. These prediction matrices W^{L}ᵢⱼ are updated by the learning of the machine learning model 200.

As can be seen from Equations (E1) to (E4), the output vector M^{L+1}ⱼ of each node of the upper layer L+l is obtained by the following calculation:

(a) the prediction vector vᵢⱼ is obtained by multiplying the output vector M^{L}ᵢ of each node in the lower layer L by the prediction matrix W^{L}ᵢⱼ,

(b) the sum vector uⱼ, which is the sum of the prediction vectors vᵢⱼ obtained from each node of the lower layer L, that is, the linear combination, is obtained,

(c) the activation value aⱼ which is the normalization coefficient is obtained by normalizing the norm |uⱼ| of the sum vector uⱼ, and

(d) the sum vector uⱼ is divided by the norm |uⱼ| and further multiplied by the activation value aⱼ.

The activation value aⱼ is the normalization coefficient obtained by normalizing the norm |uⱼ| for all the nodes in the upper layer L+1. Therefore, the activation value aⱼ can be considered an index showing a relative output intensity of each node among all the nodes in the upper layer L+1. The norm used in Equations (E3), (E3a), (E3b), and (4) is an L2 norm indicating a vector length in a typical example. At this time, the activation value aⱼ corresponds to a vector length of the output vector M^{L+1}ⱼ. Since the activation value aⱼ is only used in Equations (E3) and (E4), the activation value aⱼ is not necessary to be output from the node. However, it is also possible to configure the upper layer L+1 such that the activation value aⱼ is output to the outside.

A configuration of a vector neural network is substantially the same as a configuration of a capsule network, and the vector neuron of the vector neural network corresponds to a capsule of the capsule network. However, the calculation according to Equations (E1) to (E4) used in the vector neural network is different from the calculation used in the capsule network. A biggest difference between the two networks is that in the capsule network, the prediction vector vᵢⱼ on a right side of Equation (E2) is multiplied by a weight, and the weight is searched by repeating dynamic routing a plurality of times. On the other hand, in the vector neural network of the present embodiment, since the output vector M^{L+1}ⱼ can be obtained by performing calculation of Equations (E1) to (E4) once in order, it is not necessary to repeat the dynamic routing, and the calculation is faster, which is an advantage. In addition, there is also an advantage that in the vector neural network of the present embodiment, an amount of memory required for calculation is smaller than that of the capsule network, and according to an experiment of the inventor of the present disclosure, the amount of memory of about ½ to ⅓ is sufficient.

In terms of using a node that receives and outputs a vector, the vector neural network is the same as the capsule network. Therefore, the advantage of using the vector neuron is also common to the capsule network. In addition, in the plurality of layers 210 to 250, a feature of a larger region is expressed as going to a higher level and a feature of a smaller region is expressed as going to a lower level, which is the same as a normal convolutional neural network. Here, the “feature” refers to a characteristic portion included in the input data to be input to a neural network. The vector neural network and the capsule network are superior to the normal convolutional neural network in that an output vector of a certain node includes spatial information that represents spatial information of the feature represented by the node. That is, a vector length of an output vector of a certain node represents an existence probability of a feature represented by the node, and a vector direction represents spatial information such as a direction and a scale of the feature. Therefore, vector directions of output vectors of two nodes belonging to the same layer represent a positional relationship of respective features. Alternatively, it can be said that the vector directions of the output vectors of the two nodes represent a variation of the features. For example, in a case of a node corresponding to a feature of an “eye”, a direction of an output vector may represent variations such as a size of the eye, a way of lifting, and the like. In the normal convolutional neural network, it is said that the spatial information of the feature is lost due to a pulling processing. As a result, the vector neural network or the capsule network has an advantage of being excellent in performance for identifying the input data as compared with the normal convolutional neural network.

Advantages of the vector neural network can also be considered as follows. That is, in the vector neural network, there is an advantage that the output vector of the node expresses the feature of the input data as coordinates in a continuous space. Therefore, the output vector can be evaluated such that the features are similar if the vector directions are close. In addition, there is also an advantage that, even if the feature included in the input data is not covered by the training data, the feature can be discriminated by interpolation. On the other hand, the normal convolutional neural network has a disadvantage that the features of the input data cannot be expressed as coordinates in a continuous space since the pooling processing causes random compression.

Since the outputs of the nodes of the ConvVN2 layer 240 and the ClassVN layer 250 are also determined in the same manner by using Equations (E1) to (E4), detailed descriptions thereof will be omitted. A resolution of the ClassVN layer 250, which is the uppermost layer, is 1×1, and the number of channels is n1.

The output of the classVN layer 250 is converted into a plurality of determination values Class 0 to Class 2 for the known class. These determination values are usually values normalized by the softmax function. Specifically, for example, the determination value for each class can be obtained by executing a calculation of calculating the vector length of the output vector based on the output vector of each node of the ClassVN layer 250 and normalizing the vector length of each node by the softmax function. As described above, the activation value aⱼ obtained by Equation (E3) is a value corresponding to the vector length of the output vector M^{L+1}ⱼ and is normalized. Therefore, the activation value aⱼ in each node of the ClassVN layer 250 may be output and used as it is as the determination value for each class.

In the above embodiment, as the machine learning model 200, the vector neural network for obtaining the output vector by the calculation of Equations (E1) to (E4) is used, but the capsule network disclosed in U.S. Pat. No. 5,210,798 or WO2019/083553 may be used instead.

### OTHER EMBODIMENTS

The present disclosure is not limited to the embodiments described above and can be implemented in various aspects without departing from the scope of the present disclosure. For example, the present disclosure can be implemented by the following aspects. In order to solve apart or all of problems of the present disclosure, or to achieve a part or all of effects of the present disclosure, technical characteristics in the above embodiments corresponding to technical characteristics in aspects described below can be replaced or combined as appropriate. If the technical characteristics are not described as essential in the present specification, the technical characteristics can be deleted as appropriate.

(1) According to a first aspect of the present disclosure, there is provided a method of discriminating a class of data to be discriminated using a vector neural network type machine learning model including a plurality of vector neuron layers. The method includes: (a) a step of preparing, for each class of one or more classes, a known feature spectrum group obtained based on an output of a specific layer among the plurality of vector neuron layers when a plurality of pieces of training data are input to the machine learning model; and (b) a step of executing a class discrimination processing of the data to be discriminated using the machine learning model and the known feature spectrum group. The step (b) includes: (b1) a step of calculating a feature spectrum based on an output of the specific layer according to an input of the data to be discriminated to the machine learning model; (b2) a step of calculating a similarity between the feature spectrum and the known feature spectrum group for each class of the one or more classes; (b3) a step of creating an explanatory text of a class discrimination result for the data to be discriminated according to the similarity; and (b4) a step of outputting the explanatory text.

According to this method, since the explanatory text of the class discrimination result is created and output using the similarity for the feature vector, the user can know the basis of the class discrimination result.

(2) In the above method, the specific layer may have a configuration in which vector neurons arranged on a plane defined by two axes including a first axis and a second axis are arranged as a plurality of channels along a third axis that is in a direction different from those of the two axes, and in the specific layer, when a region which is specified by a plane position defined by a position in the first axis and a position in the second axis and which includes the plurality of channels along the third axis is referred to as a partial region, for each partial region of a plurality of partial regions included in the specific layer, the feature spectrum may be obtained as any one of: (i) a feature spectrum of a first type in which a plurality of element values of an output vector of each of the vector neurons included in the partial region are arranged over the plurality of channels along the third axis, (ii) a feature spectrum of a second type obtained by multiplying each of the element values of the feature spectrum of the first type by a normalization coefficient corresponding to a vector length of the output vector, and (iii) a feature spectrum of a third type in which the normalization coefficient is arranged over the plurality of channels along the third axis.

According to this method, the similarity can be obtained by using any one of the three types of feature spectra obtained based on the output vector of the specific layer.

(3) In the above method, the similarity obtained in the step (b2) may be a local similarity obtained for each of the partial regions.

According to this method, the explanatory text can be created according to the local similarity obtained for each of the partial regions of the specific layer.

(4) In the above method, when Ns and Nd are integers of 2 or more, Nd≤Ns, and Nc is an integer of 1 or more, the step (b3) may include: a first step of creating Nd pieces of table input data, in which the number of gradations thereof is smaller than that of the local similarity, based on Ns local similarities for at least Ns partial regions which is a part of the plurality of partial regions included in the specific layer; a second step of obtaining Nc character strings output from a character string lookup table prepared in advance by inputting the Nd pieces of table input data into the character string lookup table; and a third step of creating the explanatory text by applying the Nc character strings to a explanatory text template including Nc character string frames.

According to this method, the explanatory text can be created by using the character string lookup table and the explanatory text template.

(5) In the above method, the integer Nd may be smaller than the integer Ns, and the first step may include: obtaining Nd representative similarities by grouping the Ns local similarities into Nd groups and obtaining a representative value of the local similarities of each of the groups; and creating the Nd pieces of table input data by reducing the number of gradations of the Nd representative similarities.

According to this method, the explanatory text can be created according to the representative similarity obtained by obtaining the representative value of the local similarities of the partial region.

(6) In the above method, the local similarity for each of the partial regions may be calculated as any one of: a local similarity of a first type which is a similarity between the feature spectrum obtained based on the output of the partial region of the specific layer according to the data to be discriminated and all of the known feature spectra associated with the specific layer and each class of the one or more classes; and a local similarity of a second type which is a similarity between the feature spectrum obtained based on the output of the partial region of the specific layer according to the data to be discriminated and all of the known feature spectra associated with the partial region of the specific layer and each class of the one or more classes.

According to this method, the local similarity can be obtained by relatively simple calculation.

(7) In the above method, the step (b4) may include: displaying a discrimination result list in which the class discrimination result and the explanatory text are arranged for two or more classes among a plurality of classes that are discriminable by the machine learning model.

According to this method, it is possible to know a basis of the class discrimination result for two or more classes.

(8) According to a second aspect of the present disclosure, there is provided an information processing device that executes a class discrimination processing of discriminating a class of data to be discriminated using a vector neural network type machine learning model including a plurality of vector neuron layers. This information processing device includes a memory configured to store the machine learning model; and a processor configured to perform calculation using the machine learning model. The processor is configured to execute: (a) a processing of reading, from the memory, a known feature spectrum group for each class of one or more classes, the known feature spectrum group being obtained based on an output of a specific layer among the plurality of vector neuron layers when a plurality of pieces of training data are input to the machine learning model; and (b) a processing of executing the class discrimination processing of the data to be discriminated using the machine learning model and the known feature spectrum group. The processing (b) includes: (b1) a processing of calculating a feature spectrum based on an output of the specific layer according to an input of the data to be discriminated to the machine learning model; (b2) a processing of calculating a similarity between the feature spectrum and the known feature spectrum group for each class of the one or more classes; (b3) a processing of creating an explanatory text of a class discrimination result for the data to be discriminated according to the similarity; and (b4) a processing of outputting the explanatory text.

According to this information processing device, since the explanatory text of the class discrimination result is created and output using the similarity for the feature vector, the user can know the basis of the class discrimination result.

(9) According to a third aspect of the present disclosure, there is provided a non-transitory computer-readable storage medium storing a computer program causing a processor to execute a class discrimination processing of discriminating a class of data to be discriminated using a vector neural network type machine learning model including a plurality of vector neuron layers. The computer program is a computer program causing the processor to execute (a) a processing of reading, from a memory, a known feature spectrum group for each class of one or more classes, the known feature spectrum group being obtained based on an output of a specific layer among the plurality of vector neuron layers when a plurality of pieces of training data are input to the machine learning model; and (b) a processing of executing the class discrimination processing of the data to be discriminated using the machine learning model and the known feature spectrum group. The processing (b) includes: (b1) a processing of calculating a feature spectrum based on an output of the specific layer according to an input of the data to be discriminated to the machine learning model; (b2) a processing of calculating a similarity between the feature spectrum and the known feature spectrum group for each class of the one or more classes; (b3) a processing of creating an explanatory text of a class discrimination result for the data to be discriminated according to the similarity; and (b4) a processing of outputting the explanatory text.

According to this computer program, since the explanatory text of the class discrimination result is created and output using the similarity for the feature vector, the user can know the basis of the class discrimination result.

The present disclosure may be implemented in various aspects other than those described above. For example, the present disclosure can be implemented in a form of a computer program for implementing a function of a class discrimination device, a non-transitory storage medium in which the computer program is recorded, and the like.

What is claimed is:

1. A method for discriminating a class of data to be discriminated using a vector neural network type machine learning model including a plurality of vector neuron layers, the method comprising:
(a) a step of preparing, for each class of one or more classes, a known feature spectrum group obtained based on an output of a specific layer among the plurality of vector neuron layers when a plurality of pieces of training data are input to the machine learning model; and
(b) a step of executing a class discrimination processing of the data to be discriminated using the machine learning model and the known feature spectrum group, wherein
the step (b) includes:
(b1) a step of calculating a feature spectrum based on an output of the specific layer according to an input of the data to be discriminated to the machine learning model;
(b2) a step of calculating a similarity between the feature spectrum and the known feature spectrum group for each class of the one or more classes;
(b3) a step of creating an explanatory text of a class discrimination result for the data to be discriminated according to the similarity; and
(b4) a step of outputting the explanatory text.

2. The method according to claim 1, wherein
the specific layer has a configuration in which vector neurons arranged on a plane defined by two axes including a first axis and a second axis are arranged as a plurality of channels along a third axis that is in a direction different from those of the two axes,
in the specific layer, when a region which is specified by a plane position defined by a position in the first axis and a position in the second axis and which includes the plurality of channels along the third axis is referred to as a partial region, for each partial region of a plurality of partial regions included in the specific layer, the feature spectrum is obtained as any one of:
(i) a feature spectrum of a first type in which a plurality of element values of an output vector of each of the vector neurons included in the partial region are arranged over the plurality of channels along the third axis,
(ii) a feature spectrum of a second type obtained by multiplying each of the element values of the feature spectrum of the first type by a normalization coefficient corresponding to a vector length of the output vector, and
(iii) a feature spectrum of a third type in which the normalization coefficient is arranged over the plurality of channels along the third axis.

3. The method according to claim 2, wherein
the similarity obtained in the step (b2) is a local similarity obtained for each of the partial regions.

4. The method according to claim 3, wherein
when Ns and Nd are integers of 2 or more, Nd Ns, and Nc is an integer of 1 or more,
the step (b3) includes:
a first step of creating Nd pieces of table input data, in which the number of gradations thereof is smaller than that of the local similarity, based on Ns local similarities for at least Ns partial regions which is a part of the plurality of partial regions included in the specific layer;
a second step of obtaining Nc character strings output from a character string lookup table prepared in advance by inputting the Nd pieces of table input data into the character string lookup table; and
a third step of creating the explanatory text by applying the Nc character strings to a explanatory text template including Nc character string frames.

5. The method according to claim 4, wherein
the integer Nd is smaller than the integer Ns, and the first step includes:
obtaining Nd representative similarities by grouping the Ns local similarities into Nd groups and obtaining a representative value of the local similarities of each of the groups; and
creating the Nd pieces of table input data by reducing the number of gradations of the Nd representative similarities.

6. The method according to claim 3, wherein
the local similarity for each of the partial regions is calculated as any one of:
a local similarity of a first type which is a similarity between the feature spectrum obtained based on the output of the partial region of the specific layer according to the data to be discriminated and all of the known feature spectra associated with the specific layer and each class of the one or more classes; and
a local similarity of a second type which is a similarity between the feature spectrum obtained based on the output of the partial region of the specific layer according to the data to be discriminated and all of the known feature spectra associated with the partial region of the specific layer and each class of the one or more classes.

7. The method according to claim 1, wherein
the step (b4) includes:
displaying a discrimination result list in which the class discrimination result and the explanatory text are arranged for two or more classes among a plurality of classes that are discriminable by the machine learning model.

8. An information processing device that executes a class discrimination processing of discriminating a class of data to be discriminated using a vector neural network type machine learning model including a plurality of vector neuron layers, the information processing device comprising:
a memory configured to store the machine learning model; and
a processor configured to perform calculation using the machine learning model, wherein
the processor is configured to execute:
(a) a processing of reading, from the memory, a known feature spectrum group for each class of one or more classes, the known feature spectrum group being obtained based on an output of a specific layer among the plurality of vector neuron layers when a plurality of pieces of training data are input to the machine learning model; and
(b) a processing of executing the class discrimination processing of the data to be discriminated using the machine learning model and the known feature spectrum group, and
the processing (b) includes:
(b1) a processing of calculating a feature spectrum based on an output of the specific layer according to an input of the data to be discriminated to the machine learning model;
(b2) a processing of calculating a similarity between the feature spectrum and the known feature spectrum group for each class of the one or more classes;
(b3) a processing of creating an explanatory text of a class discrimination result for the data to be discriminated according to the similarity; and
(b4) a processing of outputting the explanatory text.

9. A non-transitory computer-readable storage medium storing a computer program causing a processor to execute a class discrimination processing of discriminating a class of data to be discriminated using a vector neural network type machine learning model including a plurality of vector neuron layers, the computer program causing the processor to execute:
(a) a processing of reading, from a memory, a known feature spectrum group for each class of one or more classes, the known feature spectrum group being obtained based on an output of a specific layer among the plurality of vector neuron layers when a plurality of pieces of training data are input to the machine learning model; and
(b) a processing of executing the class discrimination processing of the data to be discriminated using the machine learning model and the known feature spectrum group, wherein
the processing (b) includes:
(b1) a processing of calculating a feature spectrum based on an output of the specific layer according to an input of the data to be discriminated to the machine learning model;
(b2) a processing of calculating a similarity between the feature spectrum and the known feature spectrum group for each class of the one or more classes;
(b3) a processing of creating an explanatory text of a class discrimination result for the data to be discriminated according to the similarity; and
(b4) a processing of outputting the explanatory text.
